(19) United States
(12) Patent Application Publication
(10) Pub. No.: US 2024/0198370 A1
(43) Pub. Date: Jun. 20, 2024

(54) SPRING FOAM PUMP AND PACKAGING CONTAINER

(71) Applicant: ZHUHAI ZHIRUN CARE PRODUCT CO., LTD., Zhuhai City (CN)

(72) Inventor: Guojin ZHANG, Zhuhai City (CN)

(21) Appl. No.: 18/585,752

(22) Filed: Feb. 23, 2024

Related U.S. Application Data
(63) Continuation of application No. 17/607,401, filed on Oct. 29, 2021.

(51) Int. Cl. B05B 11/10

(52) U.S. Cl. CPC B05B 11/1087; B05B 11/1067; B05B 11/1074

(57) ABSTRACT

A spring foam pump and a packaging container including the same are provided. Under the push of the pressing head (2), the liquid pump piston (71) and the air pump piston (72) force the fluid and gas in the liquid pump chamber (5) and the air pump chamber (6) to enter the gas-liquid mixing chamber (4) to form foam, respectively. Under the action of pressure, the foam flows out after passing through the foam channel (21). The sealing requirement is not very high, and it can be used in various environments. The packaging container comprises a container capable of containing fluid and the spring foam pump.

### CROSS REFERENCE TO RELATED APPLICATION

This application is a continuation of U.S. application Ser. No. 17/607,401, entitled “SPRING FOAM PUMP AND PACKAGING CONTAINER,” filed Oct. 29, 2021, and the entire contents of which are incorporated herein by reference.

### TECHNICAL FIELD

The present disclosure relates to the technical field of foam pumps, in particular to a spring foam pump, and also designs a packaging container using the spring foam pump.

### BACKGROUND

In the field of cosmetics, foam cosmetics have been widely used in daily life. People can hold different fluids in cosmetic bottles according to their needs, which are used for extrusion and spraying to form foams, and are often used for moisturizing or beautifying. In addition, foam toiletries are also widely used in daily life, such as bubble shower gel and bubble shampoo.

At present, cosmetic bottles, shower gel bottles and shampoo bottles sold in the market need to be pressed to squeeze out foam, so that they need to be provided with springs for resetting after being pressed. At present, the spring of the container bottle sold in the market is placed in the fluid flow channel, which is a traditional structure and the most commonly used one in the market. The disadvantage of this structure is that the spring is in contact with the fluid for a long time, which may lead to rust and pollute the fluid. The structure is not allowed to be used in industries with high requirements.

In addition, there is also an air pump-type foam pump in the market, which is a structure with very high requirements on sealing performance and is realized by blowing air into the bottle and adding fluid. When in use, it can be used by pressing the head and turning on the valve, but this structure is complex, and the cost is too high. Moreover, it is used at normal temperature. It is not safe enough, because it may have the risk of explosion in high temperature and open flame environment or in case of air leakage.

### SUMMARY

In order to overcome the shortcomings of the prior art, the present disclosure provides a packaging container, which adopts a spring foam pump. The spring does not pollute the fluid and is safe to use.

The technical scheme adopted by the present disclosure to solve the technical problems is as follows.

The present disclosure relates to a spring foam pump, comprising a shell and a pressing head movably provided at the upper end of the shell, wherein a foam channel is provided in the pressing head, a spring is sleeved outside the foam channel, one end of the spring abuts against the pressing head, and the other end thereof abuts against the shell, a gas-liquid mixing chamber is provided inside the upper end of the shell, a liquid pump chamber and an air pump chamber are provided at the lower end thereof, the gas-liquid mixing chamber is communicated with the foam channel, the gas-liquid mixing chamber is capable of being communicated with the liquid pump chamber and the air pump chamber, respectively, the liquid pump chamber is provided with a liquid pump piston, the air pump chamber is provided with an air pump piston, the air pump piston is integrally provided on the liquid pump piston, and the lower end of the pressing head is capable of pushing the upper end of the liquid pump piston.

As an improvement of the above technical scheme, a vertical guide groove is provided on the shell or the pressing head, a guide strip is correspondingly provided on the shell or the pressing head, an arc-shaped limiting groove is provided on the side wall of the vertical guide groove along the circumferential direction, the vertical guide groove is communicated with the limiting groove, and the limiting groove is located at one end close to the guide strip.

As an improvement of the above technical scheme, the arc surface of the limiting groove is provided with a limiting protrusion.

As an improvement of the above technical scheme, the spring foam pump further comprises a piston body, the piston body comprises the air pump piston and the liquid pump piston provided at the center of the air pump piston, the air pump piston is provided with an air hole, the air hole is communicated with the air pump chamber, the air hole is capable of being communicated with the gas-liquid mixing chamber, the center of the liquid pump piston is provided with a liquid channel, the liquid channel is communicated with the liquid pump chamber, and the liquid channel is capable of being communicated with the gas-liquid mixing chamber.

As an improvement of the above technical scheme, the piston body further comprises a pipe column provided at the upper end of the liquid pump piston, the inner wall and the outer wall of the pipe column are both provided with a plurality of ventilation grooves, the gas in the air pump chamber is capable of entering the pipe column through the air holes, the ventilation grooves on the outer wall of the pipe column, and the ventilation grooves on the inner wall of the pipe column, and the pipe column is communicated with the foam channel.

As an improvement of the above technical scheme, a gas control member is provided between the pressing head and the piston body, the upper end of the gas control member is fixedly connected with the pressing head, the gas control member comprises a first sealing pipe provided at the lower end and a second sealing pipe sleeved outside the first sealing pipe, the first sealing pipe is hermetically connected with the upper end of the second sealing pipe, the pipe column is provided between the first sealing pipe and the second sealing pipe, and the first sealing pipe is communicated with the foam channel.

As an improvement of the above technical scheme, the upper end face of the air pump piston is provided with a protruded annular sealing strip along the circumferential direction, the annular sealing strip is provided on the side of the air hole far away from the center of the air pump piston, an annular platform is provided outside the second sealing pipe, the lower end of the annular platform is provided with an annular sealing groove, and the annular sealing groove is capable of clamping or avoiding the annular sealing strip.

As an improvement of the above technical scheme, an inverted funnel ring is provided inside the upper end of the liquid pump piston, a valve core is provided inside the pipe column, the upper end of the valve core is fixedly connected with the pressing head, the lower end thereof is provided with a round table, and the round table is capable of blocking or avoiding the funnel ring.

As an improvement of the above technical scheme, the lower end of the liquid pump chamber is provided with a liquid passing pipe, a valve hole and a valve member are provided in the liquid passing pipe, the valve member is provided above the valve hole, and the valve member is capable of blocking or avoiding the valve hole.

The present disclosure relates to a packaging container, comprising a container capable of containing fluid and the spring foam pump described above, wherein the shell is installed on the container, the liquid pump chamber and the air pump chamber extend into the container, and the liquid pump chamber is capable of being communicated with the inner side of the container.

The present disclosure has the following beneficial effects.

The packaging container uses a spring foam pump. Under the push of the pressing head, the liquid pump piston and the air pump piston force the fluid and gas in the liquid pump chamber and the air pump chamber to enter the gas-liquid mixing chamber to form foam, respectively. Under the action of pressure, the foam flows out after passing through the foam channel. The sealing requirement is not very high, and it can be used in various environments. At the same time, there is no need to pressurize the container bottle, so that there is no risk of explosion, and it is very safe. In addition, the spring is sleeved outside the foam channel of the pressing head, and both ends are abutted against the pressing head and the shell, respectively. In the foaming process, the fluid and the foam are not in contact with the spring, which can prevent the spring from polluting the fluid, and can prevent the influence of the service performance since it is easy for the spring to rust when being soaked in the fluid. In addition, in the existing foam pump, the air pump piston and the liquid pump piston are of a split structure. A complex linkage structure needs to be provided between the air pump piston and the liquid pump piston in order that the pressing head can drive the air pump piston and the liquid pump piston to move in the process of movement. However, the air pump piston and the liquid pump piston of the present disclosure are integrally provided, thus omitting the complicated linkage structure in the middle, reducing product parts, making the structure simpler, facilitating assembly and reducing cost.

### BRIEF DESCRIPTION OF THE DRAWINGS

The present disclosure will be further explained with reference to the attached drawings and specific embodiments, in which:

FIG. 1 is a schematic structural diagram of a spring foam pump according to an embodiment of the present disclosure.

FIG. 2 is a partial enlarged diagram at A in FIG. 1.

FIG. 3 is a schematic structural diagram of a shell according to an embodiment of the present disclosure.

FIG. 4 is a schematic structural diagram of a pressing head according to an embodiment of the present disclosure.

### DETAILED DESCRIPTION OF THE EMBODIMENTS

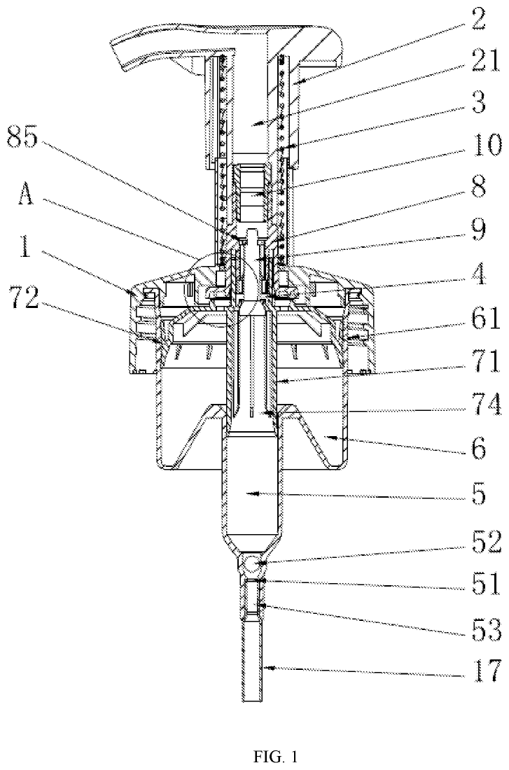

With reference to FIG. 1, the present disclosure discloses a packaging container, which comprises a container capable of containing fluid and a spring foam pump described below. The shell 1 is installed on the container, the liquid pump chamber 5 and the air pump chamber 6 extend into the container, and the liquid pump chamber 5 is capable of being communicated with the inner side of the container.

The present disclosure further discloses a spring foam pump, comprising a shell 1 and a pressing head 2 movably provided at the upper end of the shell. A foam channel 21 is provided in the pressing head 2. A spring 3 is sleeved outside the foam channel 21. One end of the spring 3 abuts against the pressing head, and the other end thereof abuts against the shell 1. A gas-liquid mixing chamber 4 is provided inside the upper end of the shell 1, and a liquid pump chamber 5 and an air pump chamber 6 are provided at the lower end thereof. The gas-liquid mixing chamber 4 is communicated with the foam channel 21. The gas-liquid mixing chamber 4 is capable of being communicated with the liquid pump chamber 5 and the air pump chamber 6, respectively. The liquid pump chamber 5 is provided with a liquid pump piston 71, and the air pump chamber 6 is provided with an air pump piston 72. The air pump piston 72 is integrally provided on the liquid pump piston 71. The lower end of the pressing head 2 is capable of pushing the upper end of the liquid pump piston 71.

The packaging container uses a spring foam pump. Under the push of the pressing head 2, the liquid pump piston 71 forces the fluid in the liquid pump chamber 5 to enter the gas-liquid mixing chamber 4, while the air pump piston 72 forces the gas in the air pump chamber 6 to enter the gas-liquid mixing chamber 4 to form foam. Under the action of pressure, the foam flows out after passing through the foam channel 21. The sealing requirement is not very high, and it can be used in various environments. At the same time, there is no need to pressurize the container bottle, so that there is no risk of explosion, and it is very safe. In addition, the spring 3 is sleeved outside the foam channel of the pressing head 2, and both ends are abutted against the pressing head 2 and the shell 1, respectively. In the foaming process, the fluid and the foam are not in contact with the spring 3, which can prevent the spring 3 from polluting the fluid, and can prevent the influence of the service performance since it is easy for the spring 3 to rust when being soaked in the fluid. In addition, in the existing foam pump, the air pump piston and the liquid pump piston are of a split structure. A complex linkage structure needs to be provided between the air pump piston and the liquid pump piston in order that the pressing head can drive the air pump piston and the liquid pump piston to move in the process of movement. However, the air pump piston 72 and the liquid pump piston 71 of the present disclosure are integrally provided, thus omitting the complicated linkage structure in the middle, reducing product parts, making the structure simpler, facilitating assembly and reducing cost.

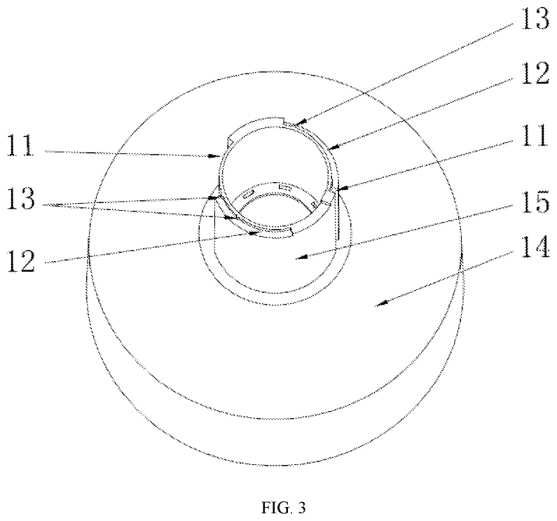

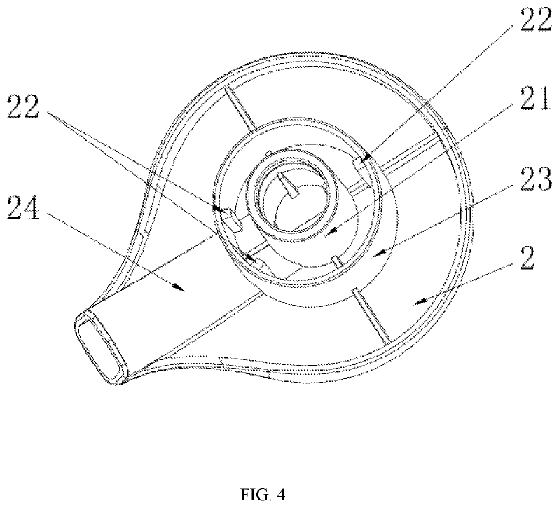

Further referring to FIG. 3 and FIG. 4, a vertical guide groove 11 is provided on the shell 1 or the pressing head 2. A guide strip 22 is correspondingly provided on the pressing head 2 or the shell 1. An arc-shaped limiting groove 12 is provided on the side wall of the vertical guide groove 11 along the circumferential direction. The vertical guide groove 11 is communicated with the limiting groove 12, and the limiting groove 12 is located at one end close to the guide strip 22. In order to prevent the pressing head 2 from rotating and losing the self-locking function in the moving process, the arc surface of the limiting groove 12 is provided with a limiting protrusion 13.

In this way, when the pressing head 2 is in a non-self-locking state, when the pressing head 2 is pressed or released, the guide strip 22 can only slide up and down in the vertical guide groove 11, and the guide strip 22 and the vertical guide groove 11 are provided to limit the rotation of the pressing head 2. When the pressing head 2 is rotated to be in a self-locking state, one end of the guide bar 22 abuts against the bottom of the limiting groove 12. The limiting groove 12 limits the pressing head 2 to move up and down, and the limiting protrusion 13 limits the rotation of the pressing head 2.

In this embodiment, the vertical guide groove 11 is provided in the shell 1, the guide bar 22 is provided on the pressing head 2, and the limiting groove 12 is located at the upper end of the shell 1. In this way, when the spring is in a natural state, that is, in a state where the pressing head 2 is not pressed downward, the pressing head 2 is rotated, so that the lower end of the guide strip 22 rotates into the limiting groove 12 and rotates to the other side of the limiting protrusion 13 through the limiting protrusion 13. At this time, the pressing head 2 cannot move upward or be pressed downward, and cannot rotate itself, thus realizing the self-locking function of the pressing head 2. The traditional foam pump uses an anti-pressure clamp to lock the pressing head 2. The self-locking structure replaces the anti-pressure clamp, so that the product parts are reduced, the structure is simpler, and it is convenient for production, injection molding and assembly, thereby reducing the manufacturing cost. Locking the pressing head 2 when not in use and opening the pressing head again when in use can effectively avoid the problems of liquid leakage and fluid oxidation caused by squeezing the pressing head 2 during transportation, carrying and storage, and avoid the inconvenience caused by the loss of the anti-pressure clamp.

Specifically, in this embodiment, the shell 1 comprises a threaded portion 14 which can be fitted on a container, and a circular ring portion 15 provided at the upper end of the threaded portion 14. The upper end of the threaded portion 14 is communicated with the inside of the circular ring portion 15, and the circular ring portion 15 is communicated with the outside air. The pressing head 2 comprises the foam channel 21 and the outer cylinder 23 which are coaxially provided, and a bubble outlet nozzle 24 which is communicated with the foam channel 21. The circular ring portion 15 can slide up and down between the foam channel 21 and the outer cylinder 23. Two vertical guide grooves 11 are formed on the outer wall of the circular ring portion 15. The width of one of the vertical guide grooves 11 is larger than that of the other of the vertical guide grooves 11. Three guide strips 22 are correspondingly provided on the inner wall of the outer cylinder 23. Two of the guide strips 22 correspond to the relatively wide vertical guide groove 11, and the other guide strip 22 corresponds to the relatively narrow vertical guide groove 11. The two vertical guide grooves 11 with different widths are provided, which can effectively prevent the pressing head 2 from being installed upside down during installation.

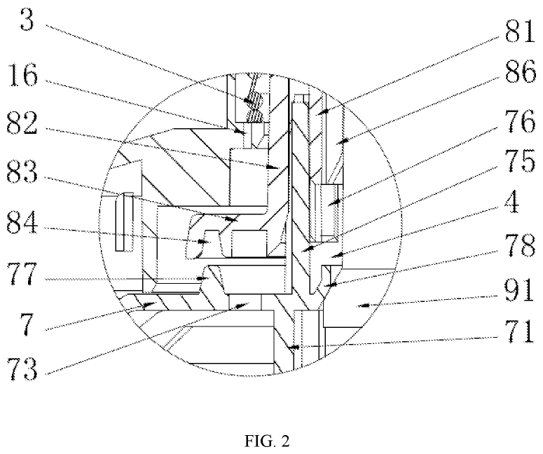

Further referring to FIG. 2, the spring foam pump further comprises a piston body 7 provided inside the threaded portion 14. The piston body 7 comprises the air pump piston 72 and the liquid pump piston 71 provided at the center of the air pump piston 72. The air pump piston is provided with an air hole 73. The air hole 73 is communicated with the air pump chamber 6, and the air hole 73 is capable of being communicated with the gas-liquid mixing chamber 4. The center of the liquid pump piston 71 is provided with a liquid channel 74. The liquid channel 74 is communicated with the liquid pump chamber 5. The liquid channel 74 is capable of being communicated with the gas-liquid mixing chamber 4. In this way, the gas in the air pump chamber 6 can enter the gas-liquid mixing chamber 4 through the air hole 73, and the fluid in the liquid pump chamber 5 can enter the gas-liquid mixing chamber 4 through the liquid channel 74.

The gas and the fluid are mixed to form foam, and the foam passes through the foam channel 21 and flows out from the bubble outlet nozzle 24.

Specifically, the piston body 7 further comprises a pipe column 75 provided at the upper end of the liquid pump piston 71. The inner wall and the outer wall of the pipe column 75 are both provided with a plurality of ventilation grooves 76. The gas in the air pump chamber 6 is capable of entering the pipe column 75 through the air holes 73, the ventilation grooves 76 on the outer wall of the pipe column, and the ventilation grooves 76 on the inner wall of the pipe column, and the pipe column 75 is communicated with the foam channel 21. The gas-liquid mixing chamber 4 is located at the inner lower end of the pipe column 75.

Furthermore, a gas control member 8 is provided between the pressing head 2 and the piston body 7. The upper end of the gas control member 8 is fixedly connected with the pressing head 2. Specifically, the upper end of the gas control element 8 is clamped in the foam channel 21. The gas control member 8 comprises a first sealing pipe 81 provided at the lower end and a second sealing pipe 82 sleeved outside the first sealing pipe. The first sealing pipe 81 is hermetically connected with the upper end of the second sealing pipe 82. The pipe column 75 is provided between the first sealing pipe 81 and the second sealing pipe 82. The inner wall and the outer wall of the pipe column 75 are in contact with the outer wall of the first sealing pipe 81 and the inner wall of the second sealing pipe 82, respectively. The first sealing pipe 81 is communicated with the foam channel 21.

In this way, the piston body 7 moves downward, the gas in the air pump chamber 6 can enter the gap between the inner wall of the second sealing pipe 82 and the outer wall of the pipe column 75 from the lower end of the second sealing pipe 82 through the air hole 73, that is, the ventilation groove 76 on the outer wall of the pipe column, reach the upper ends of the first sealing pipe 81 and the second sealing pipe 82, and then enter the gas-liquid mixing chamber 4 inside the pipe column 75 from the upper end of the first sealing pipe 81 along the gap between the outer wall of the first sealing pipe 81 and the inner wall of the pipe column 75, that is, the ventilation groove 76 on the inner wall of the pipe column.

Furthermore, a through hole 16 is provided in the lower end of the circular ring portion 15. The upper end of the threaded portion 14 is communicated with the outside air through the through hole 16, that is, the outside air can enter the air pump chamber 6 through the through hole 16 and the air hole 73.

In order to block the communication between the air hole 73 and the outside air when the pressing head 2 is pressed downward, the upper end face of the air pump piston 72 is provided with a protruded annular sealing strip 77 along the circumferential direction. The annular sealing strip 77 is provided on the side of the air hole 73 far away from the center of the air pump piston 72. An annular platform 83 is provided outside the second sealing pipe 82. The annular platform 83 located between the air pump piston 72 and the upper end of the threaded portion 14. The lower end of the annular platform 83 is provided with an annular sealing groove 84, and the annular sealing groove 84 is capable of clamping or avoiding the annular sealing strip 77. The upper side wall of the air pump chamber 6 is provided with a small hole 61. The air pump piston 72 can block or avoid the small hole 61. The container can be communicated with the upper end of the threaded portion 14 through the small hole 61.

In this way, the pressing head 2 is pressed downward, the pressing head 2 pushes the gas control member 8 to move downward, and the annular platform 83 moves downward, clamping the annular sealing strip 77 and blocking the communication between the air hole 73 and the upper end of the threaded portion 14. Thereafter, the gas control member 8 pushes the air pump piston 72 to move downward, and the gas in the air pump chamber 6 is squeezed, so that the gas will not overflow to the outside air through the air hole 73 and the through hole 16, but can enter the ventilation groove 76 of the outer wall of the pipe column through the air hole 73 at the first time, and then enter the gas-liquid mixing chamber 4. At the same time, when the air pump piston 72 moves downward, the position where the small hole 61 is provided is avoided. The outside air enters the upper end of the threaded portion 14 through the through hole 16, and then is replenished into the container through the small hole 61.

When the pressing head 2 is released, the pressing head 2 springs back to the original state before pressing under the action of the spring 3 which is a reset device. In the process, the pressing head 2 drives the gas control member 8 to move upward, and the annular sealing groove 84 also moves up above the annular sealing strip 77, avoiding the annular sealing strip 77. The outside air can be replenished to the air pump chamber 6 through the through hole 16 and the air hole 73. At the same time, the air pump piston 72 seals the small hole 61.

Accordingly, an inverted funnel ring 78 is provided inside the upper end of the liquid pump piston 71, a valve core 9 is provided inside the pipe column 75, the upper end of the valve core 9 is fixedly connected with the pressing head 2, the lower end thereof is provided with a round table 91, and the round table 91 is capable of blocking or avoiding the funnel ring 78, that is, the outer slope of the round table 91 can block the inner slope of the funnel ring 78. When the pressing head 2 is pressed downward, the valve core 9 moves downward, and the round table 91 avoids the funnel ring 78 downward, so that liquid can enter the gas-liquid mixing chamber 4 inside the pipe column 75 through the gap between the round table 91 and the funnel ring 78. When the pressing head 2 is released, the pressing head 2 drives the valve core 9 to move upward, and the outer slope of the round table 91 can block the inner slope of the funnel ring 78, thus preventing the fluid in the gas-liquid mixing chamber 4 from flowing back to the liquid pump chamber 5.

Specifically, an annular bone position 85 is provided on the inner wall of the upper end of the gas control member 8. The upper end of the valve core 9 is clamped in the central hole of the bone position 85. The bone position 85 is provided with a plurality of bubble outlet holes penetrating from top to bottom. The inner wall of the upper end of the gas control member 8 is provided with a plurality of guide ribs 86 on the lower side of the bone position 85, which is convenient to install the valve core 9. A net post 10 is installed in the foam channel 21.

Referring to FIG. 1 again, the lower end of the liquid pump chamber 5 is provided with a liquid passing pipe 53, a valve hole 51 and a valve member 52 are provided in the liquid passing pipe 53, the valve member 52 is provided above the valve hole 51, and the valve member 52 is capable of blocking or avoiding the valve hole 51. The upper end of the liquid passing pipe 53 is communicated with the liquid pump chamber 5, and the lower end thereof is provided with a suction pipe 17. When the liquid pump piston 71 moves downward, the valve member 52 blocks the valve hole 51 under the pressure of the fluid in the liquid pump chamber 5. The fluid in the liquid pump chamber 5 can only flow upward into the gas-liquid mixing chamber 4 in the pipe column 75 through the liquid passage 74. When the liquid pump piston 71 moves upward, a negative pressure is formed in the liquid pump chamber 5. The valve member 52 floats upward under the action of the negative pressure, avoiding the valve hole 51. The fluid in the container is sucked into the liquid pump chamber 5 through the suction pipe 17.

In use, when the pressing head 2 is pressed downward, the gas control member 8 moves downward, and the annular sealing groove 84 is clamped with the annular sealing strip 77 downward, so that the air hole 73 cannot be communicated with the upper end of the threaded portion 14, and the passage of the air pump chamber 6 overflowing to the outside air is cut off. At the same time, the valve core 9 is driven by the gas control member 8 to move downward, the round table 91 avoids the funnel ring 78, and the liquid channel 74 is communicated with the inside of the pipe column 75. The valve member 52 blocks the valve hole 51.

Next, the pressing head 2 continues to move downward. The pipe column 75 is pushed downward by the gas control member 8, and the piston body 7 moves downward. The gas in the air pump chamber 6 is squeezed by the air pump piston 72, enters between the annular platform 83 and the air pump piston 72 through the air holes 73, and then enters the inner lower end of the pipe column 75 through the ventilation grooves 76 on the outer wall of the pipe column and the ventilation grooves 76 on the inner wall of the pipe column. At the same time, the fluid in the liquid pump chamber 5 is squeezed by the liquid pump piston 71, and the fluid enters the inner lower end of the pipe column 75 through the gap between the round table 91 and the funnel ring 78. The inner lower end of the pipe column 75 is the gas-liquid mixing chamber 4. The gas and fluid are preliminarily mixed at the lower end of the pipe column 75 to form bubbles. The bubbles pass through the gap between the plurality of guide ribs 86 and then pass through the bubble outlet holes on the bone position 85 to form foam. The foam is divided to form dense foam through the net post 10. The foam flows out through the bubble outlet nozzle 24.

Thereafter, the pressing head 2 is released, and the pressing head 2 springs back to the original state before pressing under the action of the spring 3 which is a reset device. In the process, the gas control member 8 moves upward, and the annular sealing groove 84 avoids the annular sealing strip 77. The outside air is replenished to the air pump chamber 6 through the through hole 16 and the air hole 73. At the same time, the valve core 9 moves upward, and the round table 91 blocks the funnel ring 78 to prevent the foam from flowing back. Thereafter, the round table 91 hooks the funnel ring 78 to move upward, so that the piston body 7 returns to its original position under the pulling force of the valve core 9. The valve member 52 floats up to avoid the valve hole 51. The fluid in the container is sucked into the liquid pump chamber 5 through the suction pipe 17.

In addition, the liquid pump chamber 5 and the air pump chamber 6 have an integrated structure, and the liquid pump chamber 5 is provided at the lower end of the center of the air pump chamber 6.

In addition, in the foam pump in the prior art, an elastic plate is used as a switching valve for the gas in the container to lead to the gas-liquid mixing chamber. The elastic plate generally uses a soft rubber valve, which is relatively thin and difficult to be subjected to injection-molding. The quality of the injection-molded soft rubber valve is unstable, and the production process is complex. Moreover, when the soft rubber valve is thin, the soft rubber valve deforms easily and has poor sealing effect. When the soft rubber valve is thick, the gas in the bottle needs a great pressure intensity to lift the soft rubber valve and squeeze it into the gas-liquid mixing chamber, so that it is difficult or even impossible to press the pressing head of the foam pump, which seriously affects its use. Furthermore, with this structure, after the foam in the gas-liquid mixing chamber turns into fluid, the fluid can easily flow back into the air pump chamber, and the fluid flowing back into the air pump chamber deteriorates easily because it is in a sealed state. Moreover, the fluid will wash away the lubricating oil between the air pump piston and the air pump chamber, resulting in increased friction between the air pump piston and the air pump chamber. More strength is required to press the spring pump, resulting in poor hand feeling, unsmooth recovery of the air pump piston, failure to return to its original position, shorter pressing stroke of the spring pump and less foam output, and affecting the sealing effect. Finally, the use of the elastic plate requires many matching parts, and the structure is complex.

In the present disclosure, the piston body 7 and the gas control member 8 can be directly injection molded. The manufacturing process is simpler, the quality is stable, and the production is convenient. Furthermore, the ventilation groove 76 on the piston body 7 serves as a channel for the gas inside the container to go to the gas-liquid mixing chamber 4, so that the gas inside the container can easily reach the gas-liquid mixing chamber 4 only by slightly pressing the pressing head 2 without pushing the gas away, thus saving labor and having a good hand feeling. In addition, the sealing of the gas passage is realized in such a manner that the annular sealing strip 77 is sealed using the annular sealing groove 84, and the sealing effect is good. Furthermore, the pipe column 75 is provided between the first sealing pipe 81 and the second sealing pipe 82, and the pipe column 75 is designed to have an appropriate height. After the foam in the gas-liquid mixing chamber 4 becomes fluid, the height of these fluids in the gas-liquid mixing chamber 4 cannot exceed the height of the pipe column 75, and these fluids cannot flow back to the air pump chamber 6, so that there is no risk of backflow. Finally, compared with the existing technology using a soft rubber valve, many parts are reduced, the production cost is greatly reduced, the assembly difficulty is reduced, and the production efficiency and the product quality are improved.

The above is only a preferred embodiment of the present disclosure, but the present disclosure is not limited to the above embodiments. Any technical effects of the present disclosure achieved by any same or similar means should belong to the scope of protection of the present disclosure.

What is claimed is:

1. A spring foam pump, comprising a shell (1) and a pressing head (2) movably provided at the upper end of the shell, wherein a foam channel (21) is provided in the pressing head, a spring (3) is sleeved outside the foam channel, one end of the spring abuts against the pressing head, and the other end thereof abuts against the shell, a gas-liquid mixing chamber (4) is provided inside the upper end of the shell, a liquid pump chamber (5) and an air pump chamber (6) are provided at the lower end thereof, the gas-liquid mixing chamber (4) is communicated with the foam channel (21), the gas-liquid mixing chamber (4) is capable of being communicated with the liquid pump chamber (5) and the air pump chamber (6), respectively, the liquid pump chamber is provided with a liquid pump piston (71), the air pump chamber is provided with an air pump piston (72), the air pump piston is integrally provided on the liquid pump piston, and the lower end of the pressing head is capable of pushing the upper end of the liquid pump piston.

2. The spring foam pump according to claim 1, wherein a vertical guide groove (11) is provided on the shell or the pressing head, a guide strip (22) is correspondingly provided on the shell or the pressing head, an arc-shaped limiting groove (12) is provided on the side wall of the vertical guide groove along the circumferential direction, the vertical guide groove is communicated with the limiting groove, and the limiting groove is located at one end close to the guide strip.

3. The spring foam pump according to claim 2, wherein the arc surface of the limiting groove is provided with a limiting protrusion (13).

4. The spring foam pump according to claim 1, wherein the spring foam pump further comprises a piston body (7), the piston body (7) comprises the air pump piston (72) and the liquid pump piston (71) provided at the center of the air pump piston (72), the air pump piston is provided with an air hole (73), the air hole is communicated with the air pump chamber (6), the air hole is capable of being communicated with the gas-liquid mixing chamber, the center of the liquid pump piston (71) is provided with a liquid channel (74), the liquid channel (74) is communicated with the liquid pump chamber (5), and the liquid channel (74) is capable of being communicated with the gas-liquid mixing chamber.

5. The spring foam pump according to claim 4, wherein the piston body (7) further comprises a pipe column (75) provided at the upper end of the liquid pump piston (71), the inner wall and the outer wall of the pipe column are both provided with a plurality of ventilation grooves (76), the gas in the air pump chamber (6) is capable of entering the pipe column (75) through the air holes (73), the ventilation grooves (76) on the outer wall of the pipe column, and the ventilation grooves (76) on the inner wall of the pipe column, and the pipe column (75) is communicated with the foam channel (21).

6. The spring foam pump according to claim 5, wherein a gas control member (8) is provided between the pressing head (2) and the piston body (7), the upper end of the gas control member is fixedly connected with the pressing head (2), the gas control member (8) comprises a first sealing pipe (81) provided at the lower end and a second sealing pipe (82) sleeved outside the first sealing pipe, the first sealing pipe (81) is hermetically connected with the upper end of the second sealing pipe (82), the pipe column (75) is provided between the first sealing pipe (81) and the second sealing pipe (82), and the first sealing pipe (81) is communicated with the foam channel (21).

7. The spring foam pump according to claim 6, wherein the upper end face of the air pump piston (72) is provided with a protruded annular sealing strip (77) along the circumferential direction, the annular sealing strip (77) is provided on the side of the air hole (73) far away from the center of the air pump piston (72), an annular platform (83) is provided outside the second sealing pipe (82), the lower end of the annular platform (83) is provided with an annular sealing groove (84), and the annular sealing groove (84) is capable of clamping or avoiding the annular sealing strip (77).

8. The spring foam pump according to claim 5, wherein an inverted funnel ring (78) is provided inside the upper end of the liquid pump piston (71), a valve core (9) is provided inside the pipe column (75), the upper end of the valve core (9) is fixedly connected with the pressing head (2), the lower end thereof is provided with a round table (91), and the round table (91) is capable of blocking or avoiding the funnel ring (78).

9. The spring foam pump according to claim 1, wherein the lower end of the liquid pump chamber (5) is provided with a liquid passing pipe (53), a valve hole (51) and a valve member (52) are provided in the liquid passing pipe (53), the valve member (52) is provided above the valve hole (51), and the valve member (52) is capable of blocking or avoiding the valve hole (51).

10. A packaging container, comprising a container capable of containing fluid and the spring foam pump according to claim 1, wherein the shell (1) is installed on the container, the liquid pump chamber (5) and the air pump chamber (6) extend into the container, and the liquid pump chamber (5) is capable of being communicated with the inner side of the container.
